(19) United States
(12) Patent Application Publication
(10) Pub. No.: US 2023/0285132 A1
(43) Pub. Date: Sep. 14, 2023

(54) DEVICE FOR CURING LIGHT HARDENING RESIN

(71) Applicant: Charles Andrew Lowry, Riverton, UT (US)

(72) Inventor: Charles Andrew Lowry, Riverton, UT (US)

(21) Appl. No.: 18/198,391

(22) Filed: May 17, 2023

Related U.S. Application Data
(60) Provisional application No. 63/353,876, filed on Jun. 21, 2022.
(60) Provisional application No. 63/053,636, filed on Jul. 19, 2020.

(51) Int. Cl. A61C 13/15

(52) U.S. Cl. CPC A61C 19/003

(57) ABSTRACT

The device generally relates to a device for curing light hardening resin or resins, and more specifically, to a device for curing light hardening resins by exposure to selected light spectrum or spectrums for curing of light hardening resins through the incorporation of at least one light source which produces radiant light with the proper spectral frequency or frequencies to effect curing of light hardening resins used in combination with a gimbal wherein the resin or resins is placed.

This patent application claims the benefits of U.S. Provisional Patent Application No. 63/353,876, Filed: 21 Jun. 2022, which is incorporated by reference herein in its entirety.

### FIELD OF THE DEVICE

The device generally relates to a device for curing light hardening resin or resins, and more specifically, to a device for curing light hardening resins by exposure to selected light spectrum or spectrums for curing of light hardening resins through the incorporation of at least one light source which produces radiant light with the proper spectral frequency or frequencies to effect curing of light hardening resins used in combination with a gimbal wherein the resin or resins is placed.

### BACKGROUND OF THE DEVICE

Historically curing light hardening resins has been through the use of a chamber wherein is placed one or more light sources which produces radiant light with the proper spectral frequency or frequencies to effect curing of light hardening resin or resins within the chamber. The chamber sometimes contains a rotating platter which rotates about the vertical axis to effect a more uniform hardening of the resin or resins perpendicular to the vertical axis.

This method only effects a partial curing wherein the article to be hardened receives more radiant light with the proper spectral frequency or frequencies to effect curing of light hardening resin or resins perpendicular to the horizontal axis but lacks sufficient exposure along the horizontal axis for proper curing of light hardening resin or resins thereby resulting in the light hardening resin receiving uneven radiant light with the proper spectral frequency or frequencies exposure thereby causing the light hardening resin to harden inconsistently.

Fully curing light hardening resin or resins requires simultaneously exposing the resin or resins along horizontal axis to radiant light with the proper spectral frequency or frequencies to effect curing of light hardening resin or resins.

### SUMMARY OF THE DEVICE

The heretofore unfulfilled requirement for a means of fully curing light hardening resin or resins is herein fulfilled through the device.

What is new and improved in the device is the use of a gimbal type system wherein is mounted the resin or resins to be fully cured, which movement of the gimbal allows full and even exposure of the resin or resins to one or more selected light sources emitting one or more selected light spectrums for curing of light hardening resin.

In particular the light source will emit select spectrum or spectrums of light between 200 nanometers and 780 nanometers although it is anticipated that other frequencies such as but not limited to microwave and far infrared could also be utilized to cure light hardening resins, and therefore other frequencies of light are allowed and within the scope of the device.

The device therefore provides a means for curing light hardening resins, comprising:
at least one light source which produces radiant light with the proper spectral frequency or frequencies to effect curing of light hardening resins,
two or more rotating axis, and
optionally one or more light-conducting and/or light-reflecting elements.

The technology surrounding the manufacture and chemistry of photopolymer resin is well known and understood and not part of the device.

### BRIEF DESCRIPTION OF THE DRAWINGS

FIG. 1 depicts the device (10) consisting of the light source or sources (20) placed in such a way that the light curing resin or resins (40) can be exposed to the illumination emanating from the light source or sources (20) located without the light curing resin or resins (40).

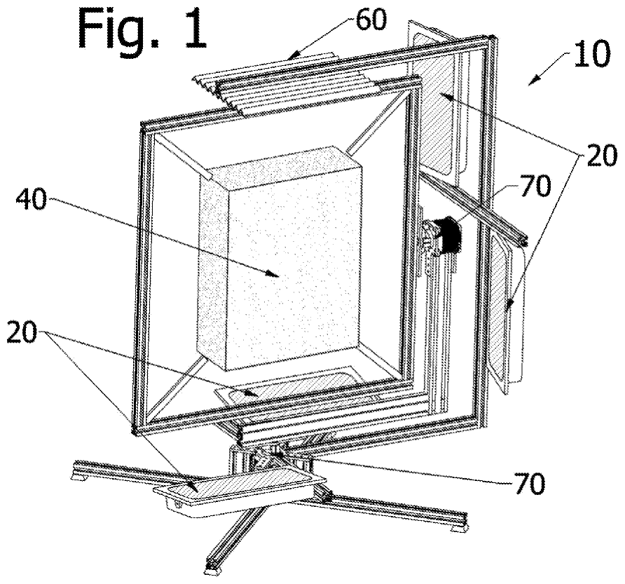

Less exposed areas may be more sufficiently and evenly irradiated by rotating the resin or resins (40) about two or more rotation axis (70) so as to effect so a more even illumination and therefore a more even curing of resin or resins (40).

Optional reflector elements (60) may also be placed external or internal to resin or resins (40) so as to redirect illumination from the light source or sources (20) to resin or resins (40).

FIG. 2 depicts the device (10) consisting of the light source or sources (20) placed in such a way that the light curing resin or resins (40) can be exposed to the illumination emanating from the light source or sources (20) located without the light curing resin or resins (40).

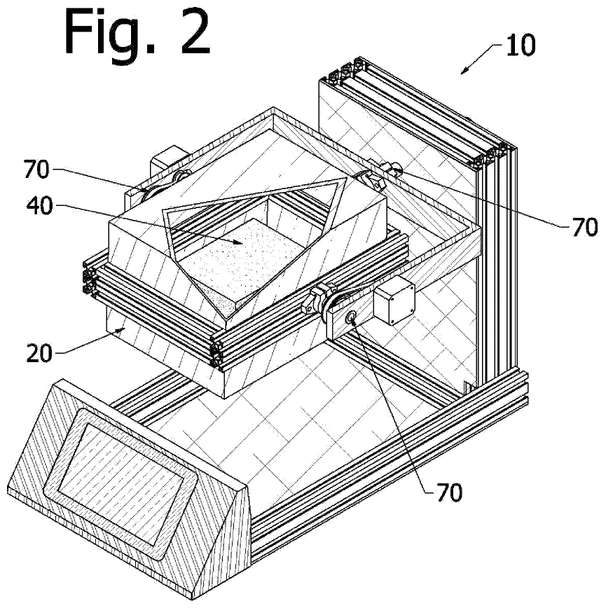

Less exposed areas may be more sufficiently and evenly irradiated by rotating the resin or resins (40) about two or more rotation axis (70) so as to effect a more even illumination and therefore a more even curing of resin or resins (40).

The embodiments and examples described only serve for explaining the device; however, they are not supposed nor intended to limit the spirit and scope of the device.

1. A device for curing light hardening resin comprising,
at least one light source which produces radiant light with the proper spectral frequency or frequencies to effect curing of light hardening resins, two or more rotating axis, and

2. The device of claim 1 optionally incorporating one or more light-conducting and/or light-reflecting elements to direct radiant light from the light source to the light hardening resin.
